(19) United States
(12) Patent Application Publication
(10) Pub. No.: US 2026/0225355 A1
(43) Pub. Date: Aug. 6, 2026

(54) WOODEN/CELLULOSIC COMPOSITE SUPPORT ELEMENT USED FOR PACKAGING

(71) Applicant: KASTAMONU ENTEGRE AGAC SANAYI VE TICARET A.S., Istanbul (TR)

(72) Inventors: Aziz BICER, Istanbul (TR); Ugur CELIK, Istanbul (TR); Ali KIZILKAYA, Kastamonu (TR); Okan YIGIT, Kastamonu (TR); Mehmet BECENE, Kastamonu (TR); Cem YILMAZ, Kastamonu (TR); Arman UNCU, Kastamonu (TR); Nazif Ozgen KUTLUATA, Kastamonu (TR); Cihan DEMIR, Kastamonu (TR); Fikri OEL, Kastamonu (TR); Erkan TABAKLI, Kastamonu (TR); Ikbal DOGANOGLU, Kastamonu (TR); Cafer KOC, Kastamonu (TR); Enus KOC, Kastamonu (TR); Abdurrahman CIFTBUDAK, Balikesir (TR)

(73) Assignee: KASTAMONU ENTEGRE AGAC SANAYI VE TICARET A.S., Istanbul (TR)

(21) Appl. No.: 19/151,341

(22) PCT Filed: Feb. 20, 2024
(86) PCT No.: PCT/TR2024/050137

§ 371 Date: Jul. 28, 2025

(30) Foreign Application Priority Data
Sep. 11, 2023 (TR) 2023/011210

(51) Int. Cl. B32B 21/02; B32B 21/06; B32B 21/08; B32B 27/30; B32B 27/32; B32B 27/36; B32B 29/06

(52) U.S. Cl. CPC B32B 21/02; B32B 21/06; B32B 21/08; B32B 27/304; B32B 27/32; B32B 27/36; B32B 29/06; B32B 2250/05; B32B 2307/718; B32B 2307/72; B32B 2307/7376; B32B 2553/00

(57) ABSTRACT

A support element which has a composite structure for use in white goods products with significant weight is provided. The support element includes at least one base and at least one paper layer, where the at least one base is made of a lignocellulosic material, and the at least one paper layer covers an outer surface of the at least one base.

### CROSS REFERENCE TO THE RELATED APPLICATIONS

This application is the national phase entry of International Application No. PCT/TR2024/050137, filed on Feb. 20, 2024, which is based upon and claims priority to Turkish Patent Application No. 2023/011210, filed on Sep. 11, 2023, the entire contents of which are incorporated herein by reference.

### TECHNICAL FIELD

The present invention is a product design for general use which provides durability in the packaging process; preferably, this product relates to a support element which has a composite structure for use in white goods products with significant weight.

### BACKGROUND

In addition to packaging material, various slat products are utilized in the white goods packaging phase. In the technical field, solid slats are widely used for this purpose. However, there are knots on the solid slats. With temperature, the resin flows out of the knots and damages the product.

In the state of the art, composite support elements made of cellulosic materials are provided instead of solid slats used in white goods packaging.

Utility model application no TR 2012/11376, known in the state of the art, describes coating a medium density fiberboard (MDF) layer on a transport pallet made of paper, which does not require heat treatment and fumigation, and thereby being able to print on the MDF layer.

Chinese patent application no CN101111376 A, known in the state of the art, discloses a formable laminate door panel. In the document, it is stated that the laminate panel includes an MDF substrate and a kraft paper that is configured on both sides of said substrate.

Chinese utility model application no CN217147000 U, known in the state of the art, discloses an iron-plastic plate packaging structure special for televisions. The structure has an MDF support layer and a side wrapping layer made of kraft paper.

### SUMMARY

The main objective of the present invention is to provide a composite support element for use in white goods packaging. Thanks to the invention, it is possible to develop a novel composite support element which provides the user with the advantage of raw material supply, saves time and labor, and which can be used in white goods packaging. In the present invention, with the MDF base, a composite support element with uniform density is manufactured and can be used in packaging without any problems.

A further objective of the invention is to provide composite strength material, which is a sustainable product and allows increasing the strength without damaging the white goods during the classification and packaging process of heavy products such as white goods.

A further objective of the invention is to develop a novel composite support element which can be an alternative to the solid slat currently used in white goods packaging.

A further objective of the invention is to develop a support element which protects the product during high piling and transportation in white goods and packaging applications.

### BRIEF DESCRIPTION OF THE DRAWINGS

The “Wooden/Cellulosic Composite Support Element Used for Packaging”, which is realized to achieve the objective of the present invention is illustrated in the accompanying figures, in which:

FIG. 1 Schematic representation of the cross-sectional structure of the composite support element according to the invention.

FIG. 2 Graphical representation of the strength of the solid slat and the composite support element according to the invention under pressure in the embodiment known in the state of the art. (X axis (horizontal axis) illustrates the number of pieces, Y axis illustrates (vertical axis) the applied pressure value)

FIG. 3 Schematic representation of the cross-sectional structure of the composite support element according to the invention in which it includes an additional layer as an alternative embodiment.

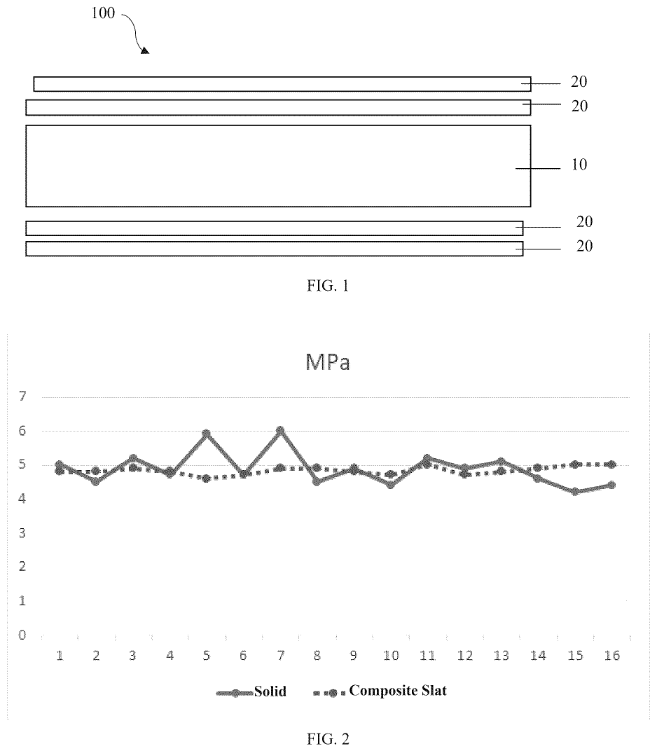

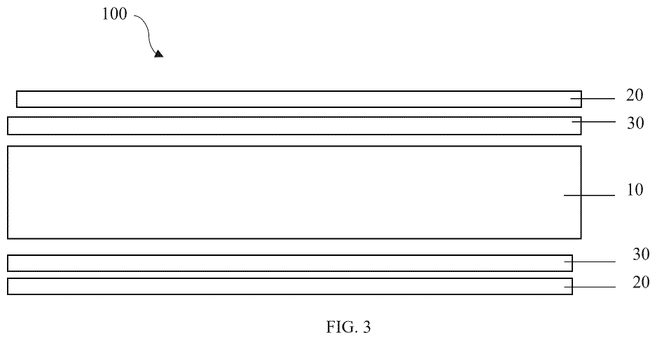

The parts shown in the figures are each given reference numerals as follows:
100. Composite Support Element
10. Base
20. Paper layer
30. Additional layer

### DETAILED DESCRIPTION OF THE EMBODIMENTS

The present invention is a composite support element (100) suitable for use as a support material which provides durability in the packaging process, in particular for white goods with significant weight, and includes:
at least one base (10), which is preferably made of any lignocellulosic material such as MDF panel, particleboard, slat, or plywood,
at least one paper layer (20) which covers the outer surface of said base (10) and which is preferably kraft paper.

In one embodiment of the invention, there is at least one additional layer (30) positioned between the base (10) and the paper layer (20) or, in case of using multiple paper layers (20), between these paper layers (20) or outside of the paper layer (20) so as to cover the entire surface. This additional layer (30) may be made of at least one metal sheet material having a surface thickness of 0.1 mm or more, or made of a polymeric material such as polyvinyl chloride (PVC), polyethylene terephthalate (PET), polypropylene (PP) having a surface thickness of 0.1 mm or more.

In one embodiment of the invention, it is preferred that the paper layer (20) used is kraft paper which meets the technical criteria of 100 gr/m² . Here, the composite support element (100) can withstand a force of 4 Mpa and above in the perpendicular compression strength test after the base (10), which is made of MDF plate, is coated with the paper layer (20), which is kraft paper. With this application, a composite support element (100) which can withstand a constant force between 4-5 Mpa can be manufactured.

The surface densities of the lignocellulosic wood-based panel used as the base (10) in the composite support element (100) according to the invention vary in the range of 1000-1200 kg/m³. Further, the average density of the said lignocellulosic wood-based panel is in the range of 800-900 kg/m³. The weight of the kraft paper applied on the said lignocellulosic wood-based panel is in the range of 50 -150 gr/m². In the final state, the surface densities of the lignocellulosic wood-based panel with the coated Kraft paper are in the range of 1200-1500 kg/m³ and the elastic modulus of the sheet increases accordingly. In this case, the perpendicular crush force increases. Thereby, while the bending resistance of the composite support element (100) manufactured at these values is >20 N/mm² and the elastic modulus is >2200 N/mm² , the minimum bending resistance after coating is >30 N/mm² and the elastic modulus is >3000 N/mm².

The composite support element (100) according to the invention can be manufactured using different materials, but the use of wooden and cellulosic materials is particularly preferred as they are cheap and recyclable. The weight distribution between the base (10) and the paper layer(s) (20) forming this composite support element (100) is preferably such that the base (10) which provides strength is 60% and the paper layer (20) which provides elasticity is 40%.

In one embodiment of the invention, the base (10) can be manufactured from cellulosic or lignocellulosic raw materials using urea formaldehyde (UF), melamine formaldehyde (MF), melamine urea formaldehyde (MUF), phenol formaldehyde (FF), polymeric methylene diphenyl isocyanate (PMDI) glues, paraffin, and glue hardener. UF, MUF and PMDI glues are preferred in the invention. In products manufactured with these glues, sheets having a bending resistance of >30 N/mm2 and elastic modulus of >3000 N/mm2 can be manufactured with the same amount of glue.

In the experimental studies carried out within the scope of the invention, as can be seen from the graph in FIG. 2, the strength in the perpendicular direction in the solid slat in the embodiment known in the state of the art is required to be equal to or above an average value of 4 Mpa. The graph in FIG. 2 shows the mechanical strength of the packaging material depending on the increase in the number of heavy products such as white goods that are packed in a stack. This value is obtained with much more deviation in solid products. On the other hand, similar values of strength are obtained in each packaged product by means of the composite support element (100) according to the invention.

The base (10) is the product obtained by impregnating the paper layer (20) on the MDF with a thickness of 6-40 mm made of cellulosic or lignocellulosic materials using at least one of melamine formaldehyde, urea formaldehyde, melamine urea formaldehyde resins of 10 g or above, and laminating it on the base (10).

What is claimed is:

1. A composite support element suitable for use as a support material, providing durability in a packaging process, in particular for white goods with significant weight, and comprising:
at least one base, wherein the at least one base is made of a lignocellulosic material, and
at least one paper layer, wherein the at least one paper layer covers an outer surface of the at least one base.

2. The composite support element according to claim 1, wherein the at least one base made of the lignocellulosic material is a medium density fiberboard (MDF) panel, a particleboard, a slat or a plywood.

3. The composite support element according to claim 2, wherein the at least one base is the MDF panel.

4. The composite support element according to claim 1, wherein the at least one paper layer which is a kraft paper.

5. The composite support element according to claim 1, further comprising at least one additional layer positioned between the at least one base and the at least one paper layer or, in case of using a plurality of paper layers, between the plurality of paper layers or outside of the plurality of paper layers to cover an entire surface.

6. The composite support element according to claim 5, wherein the at least one additional layer is made of at least one metal sheet material having a surface thickness of 0.1 mm or more, or made of a polymeric material, wherein the polymeric material is at least one of polyvinyl chloride (PVC), polyethylene terephthalate (PET) and polypropylene (PP) having a surface thickness of 0.1 mm or more.

7. The composite support element according to claim 3, wherein the at least one paper layer is a kraft paper providing a technical criteria of 100 gr/m².

8. The composite support element according to claim 1, wherein the at least one base is manufactured from cellulosic or lignocellulosic raw materials using urea formaldehyde (UF), melamine formaldehyde (MF), melamine urea formaldehyde (MUF), phenol formaldehyde (FF), polymeric methylene diphenyl isocyanate (PMDI) glues, paraffin and a glue hardener.
